(19) United States
(12) Patent Application Publication
(10) Pub. No.: US 2015/0225532 A1
(43) Pub. Date: Aug. 13, 2015

(54) PRECIPITATING NANOPARTICLES IN MONOMERS FOR PRODUCING HYBRID PARTICLES

(71) Applicant: BASF SE, Ludwigshafen (DE)

(72) Inventors: Wolfgang Gerlinger, Limburgerhof (DE); Bernd Sachweh, Meckenheim (DE); Lena Hecht, Karlsruhe (DE); Marion Winkelmann, Ludwigshafen (DE); Heike Schuchmann, Karlsruhe (DE)

(73) Assignee: BASF SE, Ludwigshafen (DE)

(21) Appl. No.: 14/427,177

(22) PCT Filed: Sep. 9, 2013
(86) PCT No.: PCT/EP2013/068580

§ 371 Date: Mar. 10, 2015

Related U.S. Application Data
(60) Provisional application No. 61/698,739, filed on Sep. 10, 2012.

(30) Foreign Application Priority Data
Sep. 10, 2012 (EP) 12183721.5

(51) Int. Cl. C08K 3/30

(52) U.S. Cl. CPC C08K 3/30; C08K 2003/3072; C08K 2003/3045

(57) ABSTRACT

The present invention relates to a process for producing hybrid nanoparticles comprising at least one inorganic material and at least one polymeric organic material, comprising at least the steps of (A) providing an emulsion comprising a disperse phase (I) comprising at least one pre-cursor compound of the at least one polymeric organic material and at least one compound which brings about the precipitation of the at least one inorganic material, a continuous aqueous phase (II), and optionally at least one compound which brings about the polymerization of the at least one precursor compound, this being present in the disperse phase (I), in the continuous aqueous phase (II) or in both phases (I) and (II), (B) adding at least one precursor compound of the at least one inorganic material to the emulsion from step (A), so as to form the at least one inorganic material by precipitation in the disperse phase, (C) optionally adding at least one compound which brings about the polymerization of the at least one precursor compound of the at least one polymeric organic material if this has not been done in step (A), and (D) polymerizing the at least one precursor compound of the at least one polymeric organic material. The present invention additionally relates to nanoparticles producible by the process according to the invention, and to the use of inventive nanoparticles in optical, electronic, chemical, agro-chemical, medical, pharmaceutical and/or biotechnological systems or for the administration of at least one active ingredient.

The present invention relates to a process for producing hybrid nanoparticles comprising at least one inorganic material and at least one polymeric organic material, comprising at least the steps of (A) providing an emulsion comprising a disperse phase (I) comprising at least one precursor compound of the at least one polymeric organic material and at least one compound which brings about the precipitation of the at least one inorganic material, a continuous aqueous phase (II), and optionally at least one compound which brings about the polymerization of the at least one precursor compound, this being present in the disperse phase (I), in the continuous aqueous phase (II) or in both phases (I) and (II), (B) adding at least one precursor compound of the at least one inorganic material to the emulsion from step (A), so as to form the at least one inorganic material by precipitation in the disperse phase, (C) optionally adding at least one compound which brings about the polymerization of the at least one precursor compound of the at least one polymeric organic material if this has not been done in step (A), and (D) polymerizing the at least one precursor compound of the at least one polymeric organic material. The present invention additionally relates to nanoparticles producible by the process according to the invention, and to the use of inventive nanoparticles in optical, electronic, chemical, agrochemical, medical, pharmaceutical and/or biotechnological systems or for the administration of at least one active ingredient.

Processes for production of hybrid nanoparticles comprising inorganic material and polymeric organic material are already known from the prior art.

J. Vidal-Vidal et al., Colloids and Surfaces A: Physiochem. Eng. Aspects 288 (2006), 44-51, disclose a process for producing monodispersed nanoparticles from maghemite by a microemulsion process. For this purpose, a dispersion in which water is emulsified in cyclohexane is prepared. In the water droplets, metal cations, especially iron(III) cations, are present, these being converted to solid iron(III) oxide by addition of a base to the dispersion by precipitation in the water droplets. This document further states that the surface of the nanoparticles thus obtained can be surface-modified, for example, with polyamines.

Winkelmann et al., Particuology 9 (2011), 502-505, likewise discloses a process for producing metal oxide nanoparticles by precipitation using a mini-emulsion. For this purpose, a mini-emulsion of water in oil is prepared, with corresponding metal oxide precursor compounds, for example iron(III) chloride, present in the water droplets. A compound, for example an amine, is added to the continuous oil phase, and this can migrate through the oil phase into the dispersed water droplets, such that the iron(III) chloride present can be converted to solid iron oxide by precipitation therein.

The prior art processes make it possible to produce corresponding metal oxide nanoparticles in water-oil emulsions, the metal oxide nanoparticles obtained being present essentially in the aqueous phase. In order to obtain hybrid nanoparticles comprising the metal oxides and polymeric compounds mentioned from these metal oxide nanoparticles, it is necessary to separate the metal oxide nanoparticles obtained from the dispersion and to transfer them to a monomer-containing dispersion for polymerization. This separation and transfer to a further emulsion constitutes a further, complex reaction step.

It was therefore an object of the present invention to provide a process for producing hybrid nanoparticles comprising at least one inorganic material and at least one polymeric organic material in a minimum number of reaction steps, with particular avoidance of the need, after the production of the inorganic materials, to transfer them into a further emulsion for production of the polymeric component.

This object is achieved in accordance with the invention by a process for producing hybrid nanoparticles comprising at least one inorganic material and at least one polymeric organic material, comprising at least the steps of:

(A) providing an emulsion comprising a disperse phase (I) comprising at least one precursor compound of the at least one polymeric organic material and at least one compound which brings about the precipitation of the at least one inorganic material, a continuous aqueous phase (II), and optionally at least one compound which brings about the polymerization of the at least one precursor compound, this being present in the disperse phase (I), in the continuous aqueous phase (II) or in both phases (I) and (II),

(B) adding at least one precursor compound of the at least one inorganic material to the emulsion from step (A), so as to form the at least one inorganic material by precipitation in the disperse phase,

(C) optionally adding at least one compound which brings about the polymerization of the at least one precursor compound of the at least one polymeric organic material if this has not been done in step (A), and

(D) polymerizing the at least one precursor compound of the at least one polymeric organic material.

In addition, the object of the invention is achieved by nanoparticles producible by the process according to the invention and by the use of these nanoparticles in optical, electronic, chemical, agrochemical, medical, pharmaceutical and/or biotechnological systems, or for the administration of at least one active ingredient.

The process according to the invention is described in detail hereinafter:

Step (A):

Step (A) of the process according to the invention comprises the provision of an emulsion comprising a disperse phase (I) comprising at least one precursor compound of the at least one polymeric organic material and at least one compound which brings about the precipitation of the at least one inorganic material, a continuous aqueous phase (II), and optionally at least one compound which brings about the polymerization of the at least one precursor compound, this being present in the disperse phase (I), in the continuous aqueous phase (II) or in both phases (I) and (II).

The disperse phase (I) present in accordance with the invention comprises at least one precursor compound of the at least one polymeric organic material. The at least one polymeric organic material present in accordance with the invention is preferably a polymer and/or copolymer. It is therefore further preferred in accordance with the invention that the at least one precursor compound of the at least one polymeric organic material present in the disperse phase (I) is a polymerizable or copolymerizable monomer.

The present invention therefore preferably relates to the process according to the invention wherein the at least one precursor compound of the at least one polymeric organic material is a polymerizable or copolymerizable monomer.

In a preferred embodiment of the process according to the invention, the at least one precursor compound of the at least one polymeric organic material is at least one olefinically unsaturated, preferably α,β-unsaturated, monomer.

The present invention therefore further preferably relates to the process according to the invention wherein the at least one precursor compound of the at least one polymeric organic material, especially the at least one monomer, is selected from the group consisting of olefinically unsaturated, preferably α,β-unsaturated, monomers and mixtures thereof.

In general, it is possible to use all the polymerizable or copolymerizable α,β-unsaturated monomers known to those skilled in the art.

Monomers, especially α,β-unsaturated monomers, which are used with preference in the process according to the present invention, are selected from the group consisting of acrylic acid, methacrylic acid, acryl esters, methacrylic esters, styrene, styrene derivatives, vinylic monomers, for example vinyl acetate, isocyanates, acrylamides, methacrylamides and mixtures thereof.

Acrylic acid, methacrylic acid, acrylic esters and methacrylic esters which are used with preference in accordance with the invention are compounds of the general formula (I)

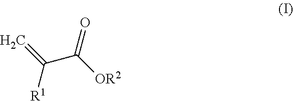

where R¹ is hydrogen (acrylic acid) or methyl (methacrylic acid) and

R² is a linear or branched, optionally substituted alkyl group having 1 to 12 carbon atoms, a linear or branched, optionally substituted alkenyl group having 2 to 12 carbon atoms, an optionally substituted aryl group having 5 to 18 carbon atoms or an optionally substituted heteroaryl group having 4 to 18 carbon atoms.

The abovementioned alkyl, alkenyl, aryl or heteroaryl groups may optionally comprise further functional groups, for example alcohol, keto or ether groups, or heteroatoms, for example, N, O, P or S.

The abovementioned aryl and heteroaryl groups may optionally be bonded to the oxygen atom of the carboxylic acid functionality by means of a saturated or unsaturated, optionally substituted, carbon chain having 1 to 12 carbon atoms, preferably 1 or 2 carbon atoms.

Styrene is known per se to those skilled in the art and corresponds to the following formula (II)

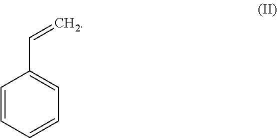

Derivatives of styrene are, for example, corresponding compounds which are derived from styrene and bear further substituents, for example methyl, on the aromatic ring and/or on the double bond. A styrene derivative used with preference is α-methylstyrene.

As precursor compounds (monomers)of the organic, polymeric materials isocyanates may also be used according to the present invention.

Isocyanates used in accordance with the invention are preferably polyisocyanates, meaning that they comprise at least two isocyanate groups. These polyisocyanates preferably react with alcohols, amines or hydroxylamines present in the mixture, preferably with diols, diamines and/or hydroxylamines, to give corresponding polyurethanes or polyureas. Corresponding isocyanates, alcohols, amines and/or hydroxylamines are known per se to those skilled in the art. Suitable isocyanates are for example toluene 2,4-diisocyanate (TDI), diphenylmethane diisocyanate or methylene diphenyl diisocyanate (MDI), hexamethylene diisocyanate (HMDI), polymeric diphenylmethane diisocyanate (PMDI), isophorone diisocyanate (IPDI), 4,4′-diisocyanatodicyclohexylmethane or mixtures thereof. Suitable diols are, for example, aliphatic or aromatic diols, polyether polyols, polyester polyols or mixtures thereof.

In a particularly preferred embodiment of the process according to the invention, the at least one monomer is selected from the group consisting of acrylic acid, butyl acrylate, benzyl acrylate, hydroxyethyl methacrylate (HEMA), 2-hydroxypropyl methacrylate (HPMA), alkyl 2-cyanoacrylates, for example cyanoethyl acrylate (ECA), methacrylic acid, methyl methacrylate (MMA), butyl methacrylate, benzyl methacrylate, styrene, a-methylstyrene, 4-vinylpyridine, vinyl chloride, vinyl alcohol, vinyl acetate, vinyl ether, N-isopropylacrylamide (NIPAM), acrylamide, methacrylamide, isocyanates and mixtures thereof.

Further preferably in the process according to the invention, the at least one polymeric organic material is selected from the group consisting of polystyrene, poly(α-methylstyrene), poly(4-vinylpyridine), poly(vinyl chloride), poly(vinyl alcohol), poly(vinyl acetate), poly(vinyl ether), polyacrylamides, polyurethanes, polyureas, poly(meth)acrylic acid, poly(meth)acrylic esters, copolymers comprising two or more of the monomers present in the aforementioned polymers, and mixtures thereof. For preparation of these preferred polymers and copolymers, preference is given in accordance with the invention to using the corresponding abovementioned monomers.

In the disperse phase, the at least one precursor compound of the at least one polymeric organic material is preferably present in an amount of 70 to 98% by weight, preferably 80 to 96% by weight, more preferably 90 to 95% by weight, based in each case on the overall disperse phase.

The emulsion provided in step (A) of the process according to the invention further comprises, in a preferred embodiment, at least one compound which brings about the polymerization of the at least one precursor compound of the at least one polymeric organic material. In a further preferred embodiment, this at least one compound which brings about the polymerization of the at least one precursor compound of the at least one polymeric organic material may also be added in step (C), i.e. after formation of the inorganic material by precipitation.

The present invention therefore preferably relates to the process according to the invention wherein the at least one compound which brings about the polymerization of the at least one precursor compound is added in step (A). In this preferred embodiment, step (C) may be dispensed with.

In the process according to the invention the polymerization in step (D) can preferably be initiated thermally and/or photolytically.

The present invention therefore preferably relates to the process according to the invention wherein the polymerization in step (D) is initiated thermally and/or photolytically. In addition, the thermally and/or photolytically initiated polymerization can be effected by free-radical, anionic or cationic means.

Depending on the way in which the polymerization is initiated, which is done in step (C) in accordance with the invention, an appropriate compound which brings about the polymerization is added to the disperse or continuous phase of the emulsion in step (A) of the process according to the invention.

In a preferred embodiment, the polymerization is thermally initiated and is effected by free-radical means.

According to the invention, it is possible to use all free-radical-forming compounds which are suitable for a thermally initiated polymerization and are known to those skilled in the art.

Preference is given to selecting at least one compound which brings about the polymerization from free-radical-forming compounds which form free radicals by thermal treatment, particular preference to selecting it from the group consisting of 2,2′-azobis(2-methylbutyronitrile), dimethyl 2,2′-azobis(2-methylpropionate), dimethyl 2,2′-azobisisobutyrate, 2,2′-azoisobutyronitrile (AIBN), dibenzoyl peroxide, water-soluble initiators, for example potassium peroxodisulfate, and mixtures thereof. Water-soluble initiators are used with preference in accordance with the invention when the addition is not effected until step (C).

In addition, it is possible in accordance with the invention also to use compounds which bring about a polymerization and which photolytically initiate the polymerization, called photoinitiators. These are known to those skilled in the art and can initiate a free-radical or ionic, for example cationic or anionic, polymerization reaction of the at least one monomer present. Since, in the case of use of photoinitiators, these have to be irradiated with light in order to initiate a polymerization, photoinitiators which generate a sufficient amount of (primary) free radicals by irradiation with light are used in accordance with the invention. In the context of the present invention, the term “light” relates to UV light or visible light, for example electromagnetic radiation having a wavelength of 150 to 800 nm, preferably 180 to 500 nm, further preferably 200 to 400 nm, more preferably 250 to 350 nm. It is preferable that photoinitiators which form appropriate free radicals by irradiation with UV light are used in accordance with the invention.

Photoinitiators used with preference in accordance with the invention for a free-radical polymerization are selected from the group consisting of 2-methyl-1-[4-(methylthio)phenyl]-2-morpholinopropan-1-one (obtainable, for example, under the Irgacure®907 brand name), 2,2′-azobisisobutyronitrile (AIBN) and further unsymmetric azo derivatives, benzoin, benzoin alkyl ethers, benzoin derivatives, acetophenones, benzyl ketals, a-hydroxyalkylphenones, α-aminoalkylphenone-acyl-α-maximinoketones, (bi)acylphosphine oxides, dioxantones and derivative, and mixtures thereof.

Photoinitiators preferred in accordance with the invention for causing a cationically initiated polymerization are selected, for example, from the group consisting of substituted diaryliodonium salt, substituted triarylphosphonium salts and mixtures thereof.

Examples of photoinitiators which are used with preference in accordance with the invention to initiate an anionic polymerization are preferably selected from the group consisting of transition metal complexes, n-alkoxypyridinium salts, n-phenylacylpyridinium salts and mixtures thereof.

According to the present invention, it is also possible to perform a “living polymerization” which is performed either in the pure polymer mixture, optionally comprising a secondary functionalization by a chain termination reagent.

The amount of at least one compound which initiates a polymerization, especially a thermally initiated free-radical polymerization in the disperse phase (I), is, in accordance with the invention, for example, 0.1 to 10% by weight, preferably 0.5 to 8% by weight and further preferably 0.8 to 6% by weight, based in each case on the overall disperse phase (I).

In addition, at least one compound which brings about the precipitation of the at least one inorganic material is present in the disperse phase (I) provided in step (A) of the process according to the invention.

The at least one compound which brings about the precipitation of the at least one inorganic material is selected in accordance with the invention such that it reacts together with the at least one precursor compound of the inorganic material in the disperse phase to give the inorganic material. For preparation of a metal oxide present with preference as the inorganic material, the at least one compound used which brings about the precipitation of the at least one inorganic material is preferably a basic compound.

Further preferably, the at least one compound which brings about the precipitation of the at least one inorganic material is selected in accordance with the invention from the group consisting of alkylamine, for example triethylamine, octylamine and mixtures thereof.

The at least one compound which brings about the precipitation of the at least one inorganic material is present, in accordance with the invention, for example, in an amount of 0.001 to 2% by weight, preferably 0.1 to 1% by weight, further preferably 0.1 to 0.5% by weight, based in each case on the overall emulsion.

The emulsion provided in step (A) of the process according to the invention comprises the at least one disperse phase (I) alongside the continuous aqueous phase (II), for example in an amount of 2 to 30% by weight, preferably 6 to 20% by weight, more preferably 8 to 12% by weight. The emulsion provided in step (A) of the process according to the invention comprises a continuous aqueous phase (II) preferably in an amount of 70 to 98% by weight, preferably 80 to 94% by weight, more preferably 88 to 92% by weight. The amounts for the disperse phase (I) and the continuous aqueous phase (II) add up in each case to 100% by weight.

The continuous aqueous phase (II) present in accordance with the invention comprises water, preferably demineralized water, as a main constituent.

In a preferred embodiment, the continuous aqueous phase (II) additionally comprises at least one emulsifier, for example selected from the group consisting of sorbates, for example polysorbate 20, polysorbate 40, polysorbate 60, polysorbate 80 and/or polysorbate 85, for example available under the Tween trade name, sodium dodecylsulfate (SDS), alkyl polyethylene glycol ethers, for example Lutensol AT 50 or Lutensol AT 80, decaglyceryl monostearate, for example SY Glyster ML-750, fatty alcohol ethoxylates, for example Emulgin B1, Emulan AF, Emulan AT 9, sodium nonylphenyl polyglycol ether sulfates, for example Emulphor NPS 25, and mixtures thereof.

The at least one emulsifier present with preference is used in an amount of, for example, 0.001 to 5% by weight, preferably 0.2 to 4% by weight, more preferably 1.5 to 2.5% by weight, based in each case on the overall continuous aqueous phase.

Water is present in the continuous aqueous phase in an amount of, for example, 95 to 99.8% by weight, preferably 96 to 99% by weight, more preferably 97.5 to 98.5% by weight, based in each case on the overall continuous aqueous phase.

The sum of the amount of at least one emulsifier and water is preferably 100% by weight.

The emulsion can be provided in step (A) of the process according to the invention by all processes known to those skilled in the art, for example separate preparation of the disperse phase (I) by mixing the individual components, preparation of the continuous aqueous phase (II) by mixing the individual components, and combination of the two phases (I) and (II), preferably with rotor-stator machines with apparatuses known to those skilled in the art, more preferably at speeds of at least 100 rpm, preferably at least 1000 rpm. Additionally preferably, in step (A) ultrasound and high-pressure homogenization is employed for provision of the emulsion, particular preference being given to using high-pressure homogenization.

Ultrasound is known to those skilled in the art as an efficient emulsification process, especially for low-viscosity disperse phases; see, for example, S. Bechtel et al., Chemie Ingenieur Technik, 71, (8), 810-817, 1999, S. Bechtel et al., Chemie Ingenieur Technik, 72, (5), 450-459, 2000, O. Behrend, Mechanisches Emulgieren mit Ultraschall [Mechanical emulsification with ultrasound], Thesis, University of Karlsruhe (TH), 2002 or S. Kentish et al. Innovative Food Science & Emerging Technologies, 9, (2), 170-175, 2008.

High-pressure homogenization is a process known to those skilled in the art for homogenization of emulsions, for example by introducing the pre-emulsion under pressure into a homogenizing valve having a homogenizing orifice. See, for example, DE 26 33 288 and S. Freitas et al., Ultrasonics Sonochemistry, 13, (1), 76-85, 2006.

The present invention therefore preferably relates to the process according to the invention wherein, in step (A) the emulsion is provided by use of high-pressure homogenization, ultrasound and/or stirring.

Preferably, in accordance with the invention, step (A) is performed at a temperature of -10 to 60° C., preferably -5 to 40° C., more preferably 0 to 25° C.

The present invention therefore preferably relates to the process according to the invention wherein step (A) is performed at a temperature of -10 to 60° C., preferably -5 to 40° C., more preferably 0 to 25° C.

After step (A), in accordance with the invention, an emulsion comprising the abovementioned disperse phase (I) and a continuous aqueous phase (II) in emulsified form is present. Preferably in accordance with the invention, this is transferred directly to step (B) of the process according to the invention.

Step (B):

Step (B) of the process according to the invention comprises the addition of at least one precursor compound of the at least one inorganic material to the emulsion from step (A), such that the at least one inorganic material forms by precipitation in the disperse phase.

According to the invention, the at least one precursor compound of the at least one inorganic material used may be any compound which is known to those skilled in the art and which, in the disperse phase (I), by reaction with the at least one compound which brings about the precipitation of the at least one inorganic material, reacts to give the at least one inorganic material present in the inventive hybrid nanoparticle.

In the process according to the invention, the at least one inorganic material is preferably at least one metal compound, the metal further preferably being selected from the group consisting of zinc, iron, titanium, tin, indium, zirconium, cerium and mixtures thereof.

More preferably in accordance with the invention, the at least one inorganic material present in step (B) is selected from the group of the metal oxides, more preferably selected from the group consisting of zinc oxide, iron oxide, titanium dioxide, tin oxide, indium oxide, zirconium dioxide, cerium oxide and mixtures thereof.

The present invention therefore preferably relates to the process according to the invention wherein the at least one inorganic material is selected from the group of the metal oxides, more preferably selected from the group consisting of zinc oxide, iron oxide, titanium dioxide, tin oxide, indium oxide, zirconium dioxide, cerium oxide and mixtures thereof.

Corresponding precursor compounds of the at least one inorganic material which is added in step (B) of the process according to the invention are therefore preferably selected from water-soluble compounds comprising the corresponding metal cation, for example selected from the group of the corresponding halides, carbonates, sulfates, phosphates, acetates, nitrates, alkoxides and mixtures thereof. Particular preference is given to using sulfates, particular preference to using zinc and/or iron(II) sulfate.

These metal compounds are preferably added in the form of an aqueous solution.

The at least one precursor compound of the at least one inorganic material is, preferably, in accordance with the invention, added in an amount of 0.001 to 2% by weight, more preferably 0.1 to 1% by weight, most preferably 0.1 to 0.5% by weight, based in each case on the overall emulsion.

Preferably, in accordance with the invention, step (B) is performed at a temperature of −10 to 60° C., preferably −5 to 40° C., more preferably 0 to 25° C.

Preferably, in accordance with the invention, the emulsion obtained in step (B) is used directly and without further steps in step (C) or (D).

Step (C):

The optional step (C) of the process according to the invention comprises the addition of at least one compound, which brings about the polymerization of the at least one precursor compound of the at least one polymeric organic material, if this has not been done in step (A).

With regard to the at least one compound which brings about the polymerization of the at least one precursor compound of the at least one polymeric organic material, the statements made for step (A) apply. If the addition is effected in step (C), preference is given to using at least one compound which brings about the polymerization of the at least one precursor compound of the at least one polymeric organic material, selected from the group consisting of water-soluble compounds, for example potassium peroxodisulfate, peroxides (e.g. hydrogen peroxide), azo initiators (e.g. 2,2′-azobis[2-(2-imidazolin-2-yl)propane] dihydrochloride, 2,2′-azobis[2-(2-imidazolin-2-yl)propane] disulfate dihydrate, 2,Z-azobis[2-(2-imidazolin-2-yl)propane]) and mixtures thereof.

Step (D):

Step (D) of the process according to the invention comprises the polymerization of the at least one precursor compound of the at least one polymeric organic material.

Depending on which compounds which bring about the polymerization have been added in step (A) or (C), the emulsion in step (D) is preferably heated and/or irradiated with light, especially with UV light, in order to bring about the polymerization.

Since, in accordance with the invention, a thermal initiation is preferred, step (D) is effected preferably at a temperature of 40 to 100° C., preferably 50 to 90° C., more preferably 60 to 80° C., performed.

On completion of production of the hybrid nanoparticles in steps (A), (B), optionally (C), and (D), they can be removed by processes known to those skilled in the art, for example by filtration, and worked up, for example by drying.

The present invention also relates to nanoparticles producible, preferably produced, by the process according to the invention. The inventive procedure of first forming an inorganic material in the disperse phase of an emulsion and, in a further step, polymerizing this disperse phase to give a polymer makes it possible in accordance with the invention to provide nanoparticles which are notable for a particularly homogeneous distribution of the inorganic material in the polymeric organic material. In addition, it is also possible in accordance with the invention that corresponding nanoparticles with a core-shell structure are formed, in which case the at least one inorganic material is present in the core and the at least one polymeric organic material in the shell. In general, in accordance with the invention, nanoparticles which, compared to one another, feature a very homogeneous distribution of inorganic and polymeric organic materials are obtained.

The inventive nanoparticles can be used, for example, in optical, electronic, chemical, agrochemical, medical, pharmaceutical and/or biotechnological systems or for the administration of at least one active ingredient.

The present invention therefore further relates to the use of inventive nanoparticles in optical, electronic, chemical, agrochemical, medical, pharmaceutical and/or biotechnological systems or for the administration of at least one active ingredient.

### EXAMPLES

The emulsion consisted of 90% by weight of continuous aqueous phase and 10% by weight of disperse phase. The continuous phase itself was produced from 98% by weight of demineralized water and 2% by weight of Tween 80 (Karl Roth GmbH and Co.). The composition of the disperse phase was 93.75% by weight of methyl methacrylate (MMA, Merck KGaA), 3.91% by weight of hexadecane as an osmotic reagent and 2.34% by weight of dimethyl 2,2′-azobisisobutyrate (V601, Wako Chemicals GmbH) or 2,2′-azoisobutyronitrile (AIBN, Wako Chemicals GmbH) as initiator. For each experiment, 30 g of the emulsion were produced. Before the continuous and disperse phases were mixed, 0.053 ml (corresponding to 0.041 g) of octylamine (Merck KGaA) was added to the disperse phase. Octylamine in the present case serves as an oil-soluble precipitation reagent.

Once the two phases had been stirred with a magnetic stirrer at 300 rpm for 10 minutes, the pre-emulsion was treated further with ultrasound. To this end, a UP 200s ultrasound processor (Hielscher Ultrasonics GmbH) was employed with an amplitude of 100% for 10 minutes. During the treatment with ultrasound, the reaction solution was cooled in an ice bath. In order to initiate the precipitation reaction, 6 ml of 0.1 molar ZnSO₄ (Merck KGaA) or FeSO₄ (Merck KGaA) were added to the emulsion. For the polymerization, the reaction solution was placed into a water bath at a temperature of 72° C. for 4 hours.

Before and after the polymerization, the emulsions were characterized by dynamic light scattering (Nanotrec, Microtrec, USA). The conversions of the monomers to polymers were determined by gravimetric means. The hybrid polymer particles were analyzed further by TEM with a LE0922, Omega.

The conversions of monomer to polymer for the AIBN and V601 initiators and the FeSO₄ and ZnSO4 precursor compounds are shown in Table 1 below.

TABLE 1

| Monomer-polymer conversion [%] | AIBN | V601 |
|---|---|---|
| FeSO₄ | 63 | 65 |
| ZnSO₄ | 62 | 64 |

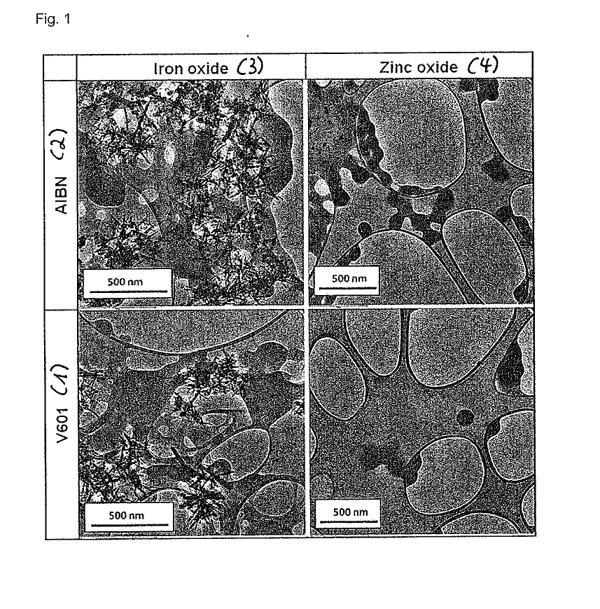

In addition, FIG. 1 shows TEM images of the individual experiments.

In FIG. 1, the meanings are:

(1) initiator V601

(2) initiator AIBN

(3) iron oxide

(4) zinc oxide

It can be shown that the choice of initiator does not significantly affect the precipitation reaction and the polymerization. For both initiators, AIBN (top) and V601 (bottom), the morphologies of the precipitated iron oxide (to the left) and zinc oxide (to the right) are similar. If the precipitation reaction of iron oxide is considered, acicular structures having a length of about 200 nm can be synthesized. The needles appear to have been formed at the surface of the polymer, and some also outside the monomer droplet. Zinc oxide particles, on the other hand, have a size of below 50 nm and are present in the polymer particles.

1. A process for producing hybrid nanoparticles comprising an inorganic material and a polymeric organic material, the process comprising:
adding at least one precursor compound (A) of the inorganic material to an emulsion comprising
a disperse phase (I) comprising a precursor compound (B) of the polymeric organic material and a first compound which brings about precipitation of the inorganic material,
a continuous aqueous phase (II), and optionally a second compound which brings about polymerization of the precursor compound (B) and which is present in at least one of the disperse phase (I) and the continuous aqueous phase (II),
so as to form the inorganic material by precipitation in the disperse phase (I),
optionally adding the second compound with the proviso that the emulsion does not comprise the second compound, and
polymerizing the precursor compound (B).

2. The process according to claim 1, wherein the inorganic material is an metal oxide.

3. The process according to claim 1, wherein the precursor compound (B) is a polymerizable or copolymerizable monomer.

4. The process according to claim 1, wherein the polymeric organic material is at least one selected from the group consisting of polystyrene, poly(a-methylstyrene), poly(4-vinylpyridine), poly(vinyl chloride), poly(vinyl alcohol), poly(vinyl acetate), poly(vinyl ether), a polyacrylamide, a polyurethane, a polyurea, poly(meth)acrylic acid, a poly(meth)acrylic ester, and a copolymer comprising two or more monomers present in the aforementioned polymers.

5. The process according to claim 1, wherein the emulsion is prepared at a temperature of from −5 to 60° C.

6. The process according to claim 1, wherein said polymerizing is initiated thermally and/or photolytically.

7. The process according to claim 1, wherein the first compound is an organic base.

8. The process according to claim 1 the emulsion is prepared by ultrasound, high-pressure homogenization and/or a rotor-stator machine.

9. The process according to claim 1, wherein the emulsion comprises the second compound which is present at least partly in the disperse phase (I).

10. Nanoparticles produced by the process according to claim 1.

11. The nanoparticles according to claim 10, wherein the inorganic material and the polymeric inorganic material are present in substantially homogeneous distribution.

12. (canceled)

13. The process according to claim 2, wherein the inorganic material is at least one selected from the group consisting of zinc oxide, iron oxide, titanium dioxide, tin oxide, and indium oxide.

14. The process according to claim 7, wherein the organic base is an alkylamine.
